(19) United States
(12) Patent Application Publication
(10) Pub. No.: US 2026/0005308 A1
(43) Pub. Date: Jan. 1, 2026

(54) LITHIUM ION BATTERY ELECTROLYTE WITH IMPROVED WETTABILITY AND LITHIUM ION BATTERY

(71) Applicant: WANXIANG A123 SYSTEMS CORP., Zhejiang (CN)

(72) Inventors: Min FU, Zhejiang (CN); Lanlan SHI, Zhejiang (CN); Min SU, Zhejiang (CN)

(21) Appl. No.: 19/294,678

(22) Filed: Aug. 8, 2025

Related U.S. Application Data
(63) Continuation of application No. PCT/CN2024/109436, filed on Aug. 2, 2024.

(30) Foreign Application Priority Data
Aug. 23, 2023 (CN) 202311066034.6

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0037

(57) ABSTRACT

A lithium ion battery electrolyte with improved wettability and a lithium ion battery is disclosed. The electrolyte includes 10% to 17% of lithium salt, 1.8% to 3.7% of film-forming additive, 0.5% to 10% of wetting additive with the balance being solvent. The wetting additive is fluorobenzene and a silanyl fluorobenzene compound, with a mass fraction of fluorobenzene in the electrolyte being at least 3% and a mass fraction of the silanyl fluorobenzene compound being not less than 1%. Two types of silanyl fluorobenzene compounds provided are mainly composed of silanyl groups which absorb HF and reduce surface tension and fluorophenyl groups which reduce surface tension. By using the silanyl fluorobenzene compounds together with fluorobenzene, a problem of performance deviation caused by generation of HF by fluorobenzene at high temperature can be solved, and wettability of the electrolyte can also be provided.

### CROSS-REFERENCE TO RELATED APPLICATIONS

This application is a Continuation of PCT International Application No. PCT/CN2024/109436 filed on Aug. 2, 2024, which claims the benefit of Chinese Patent Application No. CN 202311066034.6, filed Aug. 23, 2023, the contents of each of which are incorporated herein by reference.

### TECHNICAL FIELD

The disclosure belongs to the field of lithium ion batteries, and relates to an electrolyte, in particular to a lithium ion battery electrolyte with improved wettability and a lithium ion battery.

### BACKGROUND ART

In a manufacturing process of a lithium ion battery, wettability of electrolyte may substantially deteriorate due to high compaction density of electrode plates or low injection coefficient. Meanwhile, in a process of designing a long-life lithium ion battery, it is also necessary to consider electrolyte shortage of a battery in late cycles because of continuous consumption of the electrolyte in the cycles. If the wettability of the electrolyte is poor in this case, it may further cause a problem of electrolyte shortage or even drying-up in a local area of the electrode.

It is proposed in a Chinese patent No. CN207967203U to address a problem of poor wettability of electrolyte caused by the high compaction density of the electrode plates or the low injection coefficient by designing a battery core. Specifically, a certain distance is reserved between an outer peripheral surface of the battery core and an inner peripheral surface of a housing to form a clamping cavity, and at least one elastic buffer body is provided in the clamping cavity, and the electrolyte is pre-stored in the buffer body to solve a wettability problem of the battery core.

It is proposed in a Chinese patent No. CN112366356A to address the problem above in terms of processes, in which a most important inventive point is to roll after micro-charging. In this patent, by comparing battery cells that are not rolled, it is found that the rolling can substantially reduce lithium evolution caused by a wetting problem, and also reduce a K value of the battery cell and improve capacity.

In addition to improving the wettability through battery cell design and process design, it is proposed in a Chinese patent No. CN105355975B to act in terms of solvents and additives of the electrolyte, in which carboxylic ester is added to carbonate to reduce viscosity of the electrolyte. In terms of additives, fluoro-ether compounds, dinitrile compounds containing ether bonds and wettability improving additives are added respectively.

The wettability improving additives are mainly epoxy fluorinated compounds. By comparing surface tension, wetting time, high-temperature cycling, high-temperature storage, DC internal resistance and rate performance, it is found that wetting performance, cycling, storage and other performance can be substantially improved by designing solvent and additive components.

In order to overcome a problem of poor wettability of the electrolyte, a general idea to solve the problem is to design in terms of the battery cell, process and raw materials. If it is designed in terms of the battery cell, the wettability of the electrolyte can be improved, but capacity and energy density of the battery cell may be compromised. However, these factors need to be focused in general battery cell design, so although it is feasible to improve the wettability through the battery cell design in theory, it is difficult to use this design in an actual process due to market considerations.

It is a common method in practical production to improve the wettability of the electrolyte through design of follow-up processes of liquid injection. Although improvement in terms of the process is highly realizable, it only improves the wettability of the electrolyte in an initial stage of formation, but cannot improve the wettability of the electrolyte in a case of electrolyte shortage in middle and late cycles. Optimization in terms of the electrolyte is a convenient method, which can not only improve the wettability of the electrolyte in formation, but also improve the wettability of the electrolyte in the late cycles.

In some patents, both the solvent and additive components in the electrolyte are changed to solve the problem of poor wettability of the electrolyte. However, due to excessive introduction of solvents or additives with poor compatibility with a negative electrode, cycling performance is substantially affected and its cycle number is substantially reduced. To solve the compatibility problem, it is necessary to reduce or not apply some solvents or additives, and simplify a formula of the electrolyte as much as possible.

The problem of electrolyte wettability has always been a main problem in the formation and late cycles. When the electrolyte wettability is poor in the formation of battery cells, the formation may be incomplete, with poor stability of SEI films formed in local areas, which may results in a problem of lithium evolution during charging and discharging. However, when the problem of poor electrolyte wettability occurs in the late cycles, local lithium evolution may also occur, which may eventually result in rapid capacity attenuation. Currently, there are many patents to solve this problem, still with more or less other problems.

For example, increasing the liquid injection coefficient or decreasing an area density in a process of battery cell design may results in low energy density and poor operability, while the optimization in process has high operability, but with large capital investment and a prolonged production cycle, and wetting problem in the middle and late cycles also cannot be solved. A method of optimizing wettability by changing composition of the electrolyte is a simplest, fast and operational method.

### SUMMARY

In order to solve a problem of poor wettability of battery cells in formation and during cycles, a lithium ion battery electrolyte with improved wettability and a lithium ion battery are improved in the disclosure. The disclosure adopts a relatively simple electrolyte formula combined with a small amount of novel wettability improving additive, which can significantly improve wettability and electrochemical performance such as high-temperature cycling and rate performance.

In order to achieve the above object, the disclosure adopts following technical schemes.

A lithium ion battery electrolyte with improved wettability includes, by mass fraction, 10% to 17% of lithium salt, 1.8% to 3.7% of film-forming additive, 0.5% to 10% of wetting additive with the balance being solvent. The wetting additive is fluorobenzene and a silanyl fluorobenzene compound, with a mass fraction of fluorobenzene in the electrolyte being at least 3% and a mass fraction of the silanyl fluorobenzene compound being not less than 1%.

In order to solve a problem of poor wettability of battery cells in the formation and during cycling, the disclosure is improved based on common electrolyte. Fluorobenzene and a novel electrolyte additive are mainly added to the electrolyte, and the electrolyte additive belongs to fluorobenzene containing silanyl groups. By adding fluorobenzene and silanyl-containing fluorobenzene additives to the electrolyte, surface tension of the electrolyte and time for the electrolyte to wet the battery cell are substantially reduced. By comparing the high-temperature cycle and rate performance of the battery cell, it is found that cycle life is longer after adding new additives and capacity retention after rate discharging is higher.

Optionally, the silanyl group is —SiHₙR₃₋ₙ (n≥1), or more preferably, —SiHₙR₃₋ₙ (n≥2), or more preferably, —SiH₃, where R represents a substituent.

As a preferred embodiment of the disclosure, a structural formula of the silanyl fluorobenzene compound is shown in Formula 1 and/or Formula 2:

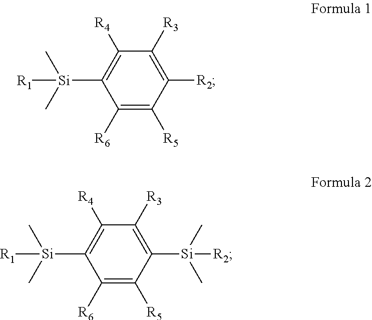

where R1, R2, R3, R4, R5 and R6 are all selected from hydrogen, halogen, substituted or unsubstituted alkanes, alkenes, alkynes, benzene rings or heterocyclic compounds.

Preferably, R1 is selected from C1 to C3 alkyl, one of silanyl groups with 0 to 3 repeating units, and halogen; R2, R3, R4, R5 and R6 are selected from one or more of fluorine atom, hydrogen atom, fluoroalkyl group, fluoroalkenyl group, fluoroether group and fluoroalkynyl group.

As a preferred embodiment of the disclosure, the silanyl fluorobenzene compound is selected from at least one of T1 to T6 as follows:

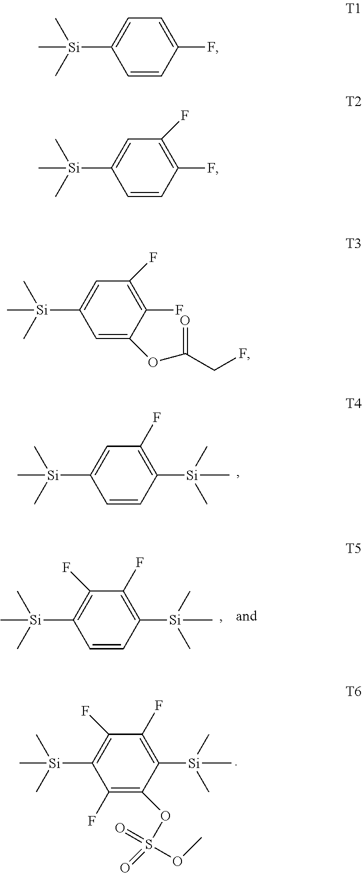

As a preferred embodiment of the disclosure, the wetting additive is combination of fluorobenzene, T3 and T6.

The disclosure relates to two silanyl fluorobenzene compounds of formula 1 and formula 2, which can be used with fluorobenzene separately or in combination. Compared with use of the two silanyl fluorobenzene compounds with fluorobenzene separately, the two silanyl fluorobenzene compounds of Formula 1 and Formula 2 are combined and used with fluorobenzene, which presents better results. Preferably, one compound is selected from T1 to T3 and T4 to T6 respectively and used together with fluorobenzene, which can better improve the wettability and prolong the cycle life.

Addition amounts of T1 to T3 and T4 to T6 compounds may directly affect the wettability of the electrolyte, but because the addition amounts of T1 to T3 and T4 to T6 compounds may affect impedance and stability of SEI, it is necessary to determine the addition amount of this additive. Preferably, the addition amount of T1 to T3 additives accounts for 0.5 to 1.5% of a total mass of the electrolyte, and the addition amount of T4 to T6 additives accounts for 1 to 2% of the total mass of the electrolyte.

Further preferably, considering that the compound containing fluorophenyl may increase a risk of self-discharging and produce hydrofluoric acid, which may results in deviation of high-temperature storage performance, and the silanyl groups can absorb hydrofluoric acid in the electrolyte, and thus increasing content of T4 to T6 facilitates improvement of storage, and connecting sulfuric acid groups to the compound facilitates formation of a stable SEI film and overcoming of shortcomings of the fluorophenyl compounds, T6 is selected from T4 to T6. Among T1 to T3, T3 connected with fluorocarboxylic ester groups presents better wetting performance, thus the addition amount of this compound is reduced and T3 is selected from T1 to T3.

Further preferably, an addition amount of fluorobenzene is generally between 3% and 10%, but excessive addition may results in degradation of high-temperature cycle and storage performance, and thus it is necessary to reduce fluorobenzene content to a minimum range. It is found from results of embodiments that an optimum result can be obtained when an addition amount of fluorobenzene is between 3% to 4%. A T6 additive can not only improve the wettability of the electrolyte, but also absorb hydrogen fluoride produced in the electrolyte. Meanwhile, it can participate in formation of the SEI film with stable performance. After further optimization, the addition amount of T6 is 1 to 1.5%. A T3 additive can improve the wettability more obviously because of its fluorocarboxylic ester groups, and further preferably, its addition amount is 0.5% to 1%.

As a preferred embodiment of the disclosure, the film-forming additive includes one or more of a carbon-containing additive, a sulfur-containing additive, a phosphorus-containing additive, a boron-containing additive, a nitrogen-containing additive and a silicon-containing additive.

As a preferred embodiment of the disclosure, the film-forming additive is one or more of vinylene carbonate, fluoroethylene carbonate, propane sultone, vinyl sulfate, methanesulfonyl dimethyl ester, tris(trimethylsilyl) phosphate, lithium oxalyldifluoroborate, lithium tetrafluorooxalate phosphate or lithium difluorophosphate.

As a preferred embodiment of the disclosure, the film-forming additive is combination of vinylene carbonate, vinyl sulfate and tris(trimethylsilyl) phosphate.

As a preferred embodiment of the disclosure, the solvent includes at least two combinations of ethylene carbonate, propylene carbonate, dimethyl carbonate, diethyl carbonate, ethyl methyl carbonate, dipropyl carbonate, ethyl acetate, methyl acetate, ethyl propionate, propyl acetate or propyl propionate.

As a preferred embodiment of the present disclosure, the lithium salt includes one or more of lithium hexafluorophosphate, lithium bis(fluorosulfonyl)imide or lithium bis(trifluoromethylsulfonyl)imide.

The disclosure further provides a lithium ion battery adopting the lithium-ion electrolyte above, which includes the lithium ion battery electrolyte, a positive electrode plate containing positive active materials, a negative electrode plate containing negative active materials and a diaphragm. The positive active materials include one or more combinations of lithium cobaltate, lithium manganate, lithium nickelate, lithium iron phosphate, ternary nickel-cobalt-manganese materials, ternary nickel-cobalt-aluminum materials, or lithium-rich and manganese-based materials, and the negative active materials include one or more combinations of artificial graphite, natural graphite, soft carbon, hard carbon, silicon, silicon carbon, or silicon oxide.

The disclosure provides a lithium ion battery for verifying performance of electrolyte additives. Firstly, the electrolyte was prepared according to test requirements, and then the electrolyte was injected into the lithium ion battery. The lithium ion battery according to the disclosure not only includes the electrolyte to be verified, but also includes a positive electrode, a negative electrode and a diaphragm.

Positive active materials of the lithium ion battery used in the disclosure includes all commonly used materials, such as one or more of lithium cobaltate, lithium manganate, lithium nickelate, lithium iron phosphate, ternary nickel-cobalt-manganese materials, ternary nickel-cobalt-aluminum materials, lithium-rich and manganese-based materials, or the like.

A main preparation method of the positive electrode plate was to select one or more of the positive active materials above, a conductive agent and a binder, polyvinylidene fluoride (PVDF), and then disperse them into an appropriate amount of N-methylpyrrolidone in a mass ratio of 95.5:2:2.5, which was then fully stirred evenly according to a slurry process. The evenly dispersed positive electrode slurry was evenly coated on aluminum foil, which was then baked, rolled, cut and punched to obtain the positive electrode plate.

Types of the negative active materials are not strictly limited in the disclosure, and current commonly used negative active materials can meet requirements of the disclosure. Specifically, the negative active materials include one or more of natural graphite, artificial graphite, hard carbon, soft carbon, silicon carbon, silicon oxide or the like.

A specific preparation process of the negative electrode plate is as follows: one or more negative active materials, a conductive agent, styrene butadiene rubber (SBR) and sodium carboxymethyl cellulose (CMC) were selected, all of raw materials were put into a star stirring tank in a mass ratio of 96:1:2:1 for preparing an uniformly dispersed negative slurry according to a slurry process. The negative electrode slurry was uniformly coated on copper foil, which was then baked, rolled, cut and punched to obtain the negative electrode plate.

A selection range of the diaphragm is not strictly limited in the disclosure, and current commonly used diaphragms all meet requirements of the disclosure, for example, one of a polypropylene diaphragm (PP), a polyethylene diaphragm (PE), a polyethylene/polypropylene double-layer composite diaphragm, a polyimide electrostatic spinning diaphragm (PI), a polypropylene/polyethylene/polypropylene triple-layer composite diaphragm (PP/PE/PP), a ceramic diaphragm, a PVDF adhesive diaphragm, or the like.

After punching of the positive and negative electrode plates, the positive electrode is placed in an oven at 110 to 140° C. and the negative electrode in an oven at 90 to 100° C. for baking. When moisture content of the electrode plates meets requirements, the positive electrode plate, the negative electrode plate and the diaphragm are placed in a laminated pole to form a bare cell, and then the bare cell is packaged in a stamping formed aluminum molded bag. After the packaged dry cell is oven dried by 80-95%, the electrolyte of the disclosure is injected into the dry cell, and the cell is stored, formed, stored at high temperature, degassed and sealed, and capacity graded to obtain the lithium ion battery.

The electrolyte additive mainly described in the disclosure is a wettability improving additive, which cannot replace other film-forming additives, and other additives need to be added for film-forming protection. Adding the film-forming additives to a electrolyte system can further optimize the performance of the lithium ion battery, especially improve cycle life and calendar life of the lithium ion battery. A main reason for this is that the film-forming additives can form CEI films and SEI films at the positive and negative electrode, and interface films formed can avoid direct contact between the electrolyte and electrode plates.

Addition of film-forming electrolyte additives can significantly affect the cycling performance, storage performance and rate performance of the battery. In order to reduce influence of the film-forming additives on electrical properties, it is necessary to optimize an addition amount of the film-forming electrolyte additives. In this disclosure, VC, DTD and TMSP are selected as standard film-forming additives, which need to be optimized.

Preferably content of VC is between 1% to 2%, content of DTD is between 0.5% to 1.2%, and content of TMSP is between 0.3% to 0.5%.

Compared with related art, the disclosure provides following beneficial effects.
1) Two types of silanyl fluorobenzene compounds provided in the disclosure are mainly composed of silanyl groups which absorb HF and reduce surface tension and fluorophenyl groups which reduce surface tension. By using the silanyl fluorobenzene compounds together with fluorobenzene, a problem of performance deviation caused by generation of HF by fluorobenzene at high temperature can be solved, and wettability of the electrolyte can also be provided. By comparing data of the high-temperature cycle and rate performance of the battery cell, advantages of the disclosure are verified.
2) A main idea of improving the wettability of the electrolyte by design of the battery core is to design a space that can accommodate the electrolyte within the lithium ion battery. This method is suitable for cylindrical and square batteries, but not for pouch cells, and leaving a part of space to contain the electrolyte may reduce bulk density and mass density of the batteries. However, improving injection processes in injecting can only improve wettability of the electrolyte in formation and capacity grading, and cannot solve a wettability problem caused by insufficient electrolyte in a long-term cycling process. It is an economical and simple method to design in terms of the electrolyte without sacrificing energy density. In the disclosure, the electrolyte is not designed in terms of solvent, but mainly in terms of additives, which can reduce interference to a conventional electrolyte formula as much as possible and reduce a risk of other performance degradation.

### DETAILED DESCRIPTION

In the following, technical schemes in embodiments of the disclosure will be described clearly and completely in connection with the embodiments; obviously, the described embodiments are intended to be only a part of the embodiment of the disclosure, but not all of them. On a basis of the embodiments in this disclosure, all other embodiments obtained by the ordinary skilled in the art without any creative effort are within a protection scope of this disclosure.

Raw materials used in the disclosure is commercially available from the market.

Except for some defined concepts, technical terms involved in following embodiments and comparative embodiments have same meanings as those involved in the field of lithium ion batteries. Reagents used in the following embodiments and comparative embodiments are all conventional chemical reagents unless otherwise specified. Experimental methods involved in the disclosure are all conventional methods. Electrochemical performance of the electrolyte of the disclosure can be illustrated by comparing data of the embodiments and comparative embodiments.

Electrolytes used in the embodiments and comparative embodiments were prepared as follows. Moisture content in a glove box was controlled to be less than 10 ppm, ethylene carbonate and methyl ethyl carbonate were put into the glove box, which were poured into a reagent bottle in a ratio of 3:7, fully stirred and frozen in a refrigerator at a temperature close to 0° C. for 1 h. Then, 1.2 mol/L lithium hexafluorophosphate was added into a mixing solvent, with stirring in adding. Then, 2% of vinylene carbonate, 1% of vinyl sulfate and 0.3% of tris(trimethylsilyl) phosphate were added, and a wettability improving additive was finally added.

A positive active material of the lithium ion battery used in these embodiments and comparative embodiments is lithium iron phosphate, its negative active material is artificial graphite, and its diaphragm is adopted as a polypropylene/polyethylene/polypropylene triple-layer composite diaphragm.

### Embodiment 1

Wettability improving additives used in this embodiment are mainly fluorobenzene and T1, with an addition amount of fluorobenzene being 3% of the electrolyte by mass fraction and an addition amount of T1 being 1% of the electrolyte by mass fraction.

### Embodiment 2

Wettability improving additives used in this embodiment are mainly fluorobenzene and T2, with an addition amount of fluorobenzene being 3% of the electrolyte by mass fraction and an addition amount of T2 being 1% of the electrolyte by mass fraction.

### Embodiment 3

Wettability improving additives used in this embodiment are mainly fluorobenzene and T3, with an addition amount of fluorobenzene being 3% of the electrolyte by mass fraction and an addition amount of T3 being 1% of the electrolyte by mass fraction.

### Embodiment 4

Wettability improving additives used in this embodiment are mainly fluorobenzene and T4, with an addition amount of fluorobenzene being 3% of the electrolyte by mass fraction and an addition amount of T4 being 1.5% of the electrolyte by mass fraction.

### Embodiment 5

Wettability improving additives used in this embodiment are mainly fluorobenzene and T5, with an addition amount of fluorobenzene being 3% of the electrolyte by mass fraction and an addition amount of T5 being 1.5% of the electrolyte by mass fraction.

### Embodiment 6

Wettability improving additives used in this embodiment are mainly fluorobenzene and T6, with an addition amount of fluorobenzene being 3% of the electrolyte by mass fraction and an addition amount of T6 being 1.5% of the electrolyte by mass fraction.

### Embodiment 7

Wettability improving additives used in this embodiment are mainly fluorobenzene, T1 and T5, with an addition amount of fluorobenzene being 3% of the electrolyte by mass fraction, an addition amount of T1 being 1% of the electrolyte by mass fraction, and an addition amount of T5 being 1.5% of the electrolyte by mass fraction.

### Embodiment 8

Wettability improving additives used in this embodiment are mainly fluorobenzene, T2 and T5, with an addition amount of fluorobenzene being 3% of the electrolyte by mass fraction, an addition amount of T2 being 1% of the electrolyte by mass fraction, and an addition amount of T5 being 1.5% of the electrolyte by mass fraction.

### Embodiment 9

Wettability improving additives used in this embodiment are mainly fluorobenzene, T3 and T5, with an addition amount of fluorobenzene being 3% of the electrolyte by mass fraction, an addition amount of T3 being 1% of the electrolyte by mass fraction, and an addition amount of T5 being 1.5% of the electrolyte by mass fraction.

### Embodiment 10

Wettability improving additives used in this embodiment are mainly fluorobenzene, T1 and T6, with an addition amount of fluorobenzene being 3% of the electrolyte by mass fraction, an addition amount of T1 being 1% of the electrolyte by mass fraction, and an addition amount of T6 being 1.5% of the electrolyte by mass fraction.

### Embodiment 11

Wettability improving additives used in this embodiment are mainly fluorobenzene, T2 and T6, with an addition amount of fluorobenzene being 3% of the electrolyte by mass fraction, an addition amount of T2 being 1% of the electrolyte by mass fraction, and an addition amount of T6 being 1.5% of the electrolyte by mass fraction.

### Embodiment 12

Wettability improving additives used in this embodiment are mainly fluorobenzene, T3 and T6, with an addition amount of fluorobenzene being 3% of the electrolyte by mass fraction, an addition amount of T3 being 1% of the electrolyte by mass fraction, and an addition amount of T6 being 1.5% of the electrolyte by mass fraction.

### Comparative Embodiment 1

In this comparative embodiment, no wettability improving additive is added.

### Comparative Embodiment 2

In this embodiment, only fluorobenzene is used as a wettability improving additive, with an addition amount being 3% of the electrolyte by mass fraction.

Electrolytes and lithium ion batteries of the embodiments and comparative embodiments were tested and compared in performance as follows:

### (1) Wettability Test of Electrolyte

The wettability test of the electrolyte in embodiments and comparative embodiments includes two tests, namely, a surface tension test of the electrolyte and a climbing time test of the electrolyte on the diaphragm. A surface tension meter is adopted in the surface tension test, while the climbing time test is to soak one end of the diaphragm in the electrolyte and suspend the other end of the diaphragm in the air, and define climbing time by measuring time for the electrolyte diffusing to a specified position. Wettability data of the embodiments and comparative embodiments in the disclosure are shown in Table 1. The smaller the surface tension, the better the wettability of the electrolyte; and the shorter the climbing time, the better the better the wettability of the electrolyte.

### (2) High-Temperature Cycling Test of Lithium Ion Battery at 45° C.

The lithium ion batteries in the embodiments and comparative embodiments are tested as follows. Firstly, the lithium ion batteries are placed in a constant temperature box at 45° C., with storing time being controlled to be over 1 hour so as to make temperature distribution uniform. Then, the lithium ion batteries are charged with a constant current and constant voltage of 1 C, with a cut-off voltage of 3.65 and a cut-off current of 0.05 C. Then the lithium ion batteries are discharged to 2 V at a constant current of 1 C. Cycling is continuously made according to above steps, and capacity retentions after 1000 cycles and 2000 cycles are recorded. The capacity retentions after 1000 and 2000 cycles are calculated by dividing capacities after 1000 and 2000 cycles by discharge capacity at a first cycle. Test data can be specifically referred to table 2.

### (3) Rate Performance Test of Lithium Ion Battery

The rate performance test is as follows. The battery cells are discharged at a constant current of 1 C to 2 V, stored for 5 minutes, and then charged to 3.65 V at a constant current and constant voltage of 0.5 C, with a cut-off current of 0.05 C. Then, the battery cells stand for 30 minutes, and then are discharged to 2V at 0.2 C, 0.5 C, 1 C, 2 C and 3 C respectively. Discharge capacities at 0.2 C, 0.5 C, 1 C, 2 C and 3 C are recorded. Taking the discharge capacity at 1 C as a reference capacity, ratios of discharge capacities at different rates to the discharge capacity at 1 C are calculated respectively. Related test results are shown in Table 3.

TABLE 1
Wettability data

| | Surface | |
|---|---|---|
| Electrolyte | tension | Climbing |
| group | mN/m | time/S |
| Embodiment 1 | 37.2 | 109 |
| Embodiment 2 | 35.6 | 110 |
| Embodiment 3 | 33.8 | 98 |
| Embodiment 4 | 34.6 | 103 |
| Embodiment 5 | 31.7 | 93 |
| Embodiment 6 | 28.9 | 87 |
| Embodiment 7 | 23.1 | 65 |
| Embodiment 8 | 22.4 | 54 |
| Embodiment 9 | 19.7 | 50 |
| Embodiment 10 | 21.6 | 57 |
| Embodiment 11 | 18.9 | 46 |
| Embodiment 12 | 15.4 | 32 |
| Comparative | 68.5 | 148 |
| Embodiment 1 | | |
| Comparative | 45.3 | 124 |
| Embodiment 2 | | |

It can be seen from the surface tension and climbing time in Table 1 that the surface tension and climbing time are substantially reduced compared with the comparative example without adding the new wettability improving additives. When the two types of wettability improving additives are combined, wetting effect of the electrolyte is improved more substantially, especially when T3 and T6 are combined, smallest surface tension and climbing time are presented. It is shown by comparison of data that the additive proposed in the disclosure significantly improves the wettability of the electrolyte.

TABLE 2
High-Temperature Cycling Test

Cycle capacity
retention at 45° C./%

| Group | 1000 cycles | 2000 cycles |
|---|---|---|
| Embodiment 1 | 91.1 | 82.2 |
| Embodiment 2 | 90.9 | 82.4 |
| Embodiment 3 | 91.0 | 82.1 |
| Embodiment 4 | 91.3 | 82.5 |
| Embodiment 5 | 91.4 | 82.4 |
| Embodiment 6 | 91.7 | 83.1 |
| Embodiment 7 | 91.4 | 82.6 |
| Embodiment 8 | 91.7 | 82.8 |
| Embodiment 9 | 91.9 | 83.4 |
| Embodiment 10 | 92.1 | 83.1 |
| Embodiment 11 | 92.3 | 83.9 |
| Embodiment 12 | 92.6 | 84.1 |
| Comparative | 90.5 | 80.5 |
| Embodiment 1 | | |
| Comparative | 90.7 | 81.4 |
| Embodiment 2 | | |

Table 2 provides data of capacity retentions of different batteries after 1000 cycles and 2000 cycles at 45° C. When fluorobenzene is not added or only added to the electrolyte, the capacity retention is relatively low. When fluorobenzene is combined with one of the wettability improving additives, the capacity retention after 1000 cycles can be slightly improved, and the capacity retention after 2000 cycles can be substantially improved, because a problem of insufficient wetting in early and middle cycles is not obvious, but after 2000 cycles, the electrolyte is reduced and this wettability problem is more obvious. When fluorobenzene is combined with the two wettability improving additives, the capacity retentions after 1000 cycles and 2000 cycles are improved substantially. When fluorobenzene is combined with T3 and T6, the capacity retentions after 1000 cycles and 2000 cycles at 45° C. is highest.

TABLE 3
Rate Performance Test

Discharge capacity retention
at different rates %

| Group | 0.2 C | 0.5 C | 1 C | 2 C | 3 C |
|---|---|---|---|---|---|
| Embodiment 1 | 107.7 | 103.7 | 100% | 96.9 | 94.2 |
| Embodiment 2 | 107.4 | 103.5 | 100% | 96.8 | 94.4 |
| Embodiment 3 | 107.0 | 103.4 | 100% | 97.0 | 94.5 |
| Embodiment 4 | 107.3 | 103.1 | 100% | 96.9 | 94.3 |
| Embodiment 5 | 106.9 | 103.3 | 100% | 97.2 | 94.6 |
| Embodiment 6 | 106.5 | 102.9 | 100% | 97.3 | 94.8 |
| Embodiment 7 | 106.3 | 102.5 | 100% | 97.6 | 95.1 |
| Embodiment 8 | 105.9 | 102.4 | 100% | 97.5 | 95.3 |
| Embodiment 9 | 105.7 | 102.1 | 100% | 97.9 | 95.5 |
| Embodiment 10 | 105.3 | 101.9 | 100% | 97.7 | 95.4 |
| Embodiment 11 | 105.2 | 101.4 | 100% | 97.9 | 95.8 |
| Embodiment 12 | 105.1 | 101.1 | 100% | 98.2 | 96.1 |
| Comparative | 108.3 | 103.9 | 100% | 96.6 | 93.8 |
| Embodiment 1 | | | | | |
| Comparative | 107.9 | 103.7 | 100% | 96.7 | 93.9 |
| Embodiment 2 | | | | | |

Table 3 lists capacity retentions of the embodiments and comparative embodiments at different rates. Compared with a lithium ion battery without adding fluorobenzene, their rate performance is slightly worse, but with less substantial difference. Rate performance of lithium ion batteries is substantially improved after adding a new wettability improving additive to the electrolyte, and especially after adding two types of wettability improving additives, the rate performance is further optimized. It is an optimum scheme in which T3 and T6 additives are added in Comparative Embodiment 2.

The above is only preferred embodiments of the present disclosure, but not intended to limit the present disclosure in any form or substantially. It should be pointed out that some improvements and supplements can be made by those of ordinary skilled in the art without departing from methods of the present disclosure, which should also be regarded to be within a protection scope of the present disclosure. Some changes, modifications and equivalent changes can be made by any of technicians who are familiar with the art by using technical content disclosed above without departing from the spirit and scope of this disclosure, which are equivalent embodiments of this disclosure. Meanwhile, any alternations, modifications and evolutions to any equivalent change made to the above-mentioned embodiments according to essential technology of the present disclosure are still within the scope of technical schemes of the disclosure.

1. A lithium ion battery electrolyte with improved wettability, comprising, by mass fraction, 10% to 17% of lithium salt, 1.8% to 3.7% of film-forming additive, 0.5% to 10% of wetting additive with the balance being solvent, wherein the wetting additive is fluorobenzene and a silanyl fluorobenzene compound, with a mass fraction of fluorobenzene in the electrolyte being at least 3% and a mass fraction of the silanyl fluorobenzene compounds being not less than 1%.

2. The lithium ion battery electrolyte with improved wettability according to claim 1, wherein a structural formula of the silanyl fluorobenzene compound is shown in Formula 1 or Formula 2, or the silanyl fluorobenzene compound is a combination of Formula 1 and Formula 2; 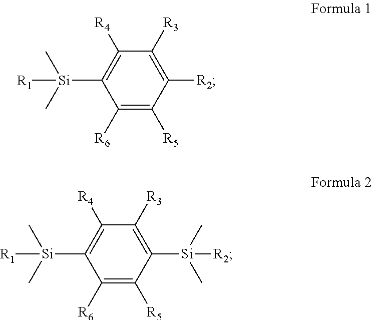
wherein R1, R2, R3, R4, R5 and R6 are all selected from hydrogen, halogen, substituted or unsubstituted alkanes, alkenes, alkynes, benzene rings or heterocyclic compounds.

3. The lithium ion battery electrolyte with improved wettability according to claim 2, wherein the silanyl fluorobenzene compound is selected from at least one of T1 to T6 as follows:

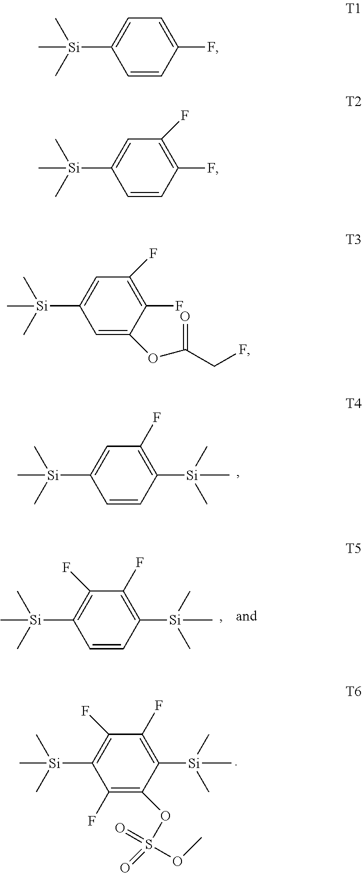

4. The lithium ion battery electrolyte with improved wettability according to claim 3, wherein the wetting additive is combination of fluorobenzene, T3 and T6.

5. The lithium ion battery electrolyte with improved wettability according to claim 1, wherein the film-forming additive comprises one or more of a carbon-containing additive, a sulfur-containing additive, a phosphorus-containing additive, a boron-containing additive, a nitrogen-containing additive and a silicon-containing additive.

6. The lithium ion battery electrolyte with improved wettability according to claim 5, wherein the film-forming additive is one or more of vinylene carbonate, fluoroethylene carbonate, propane sultone, vinyl sulfate, methanesulfonyl dimethyl ester, tris(trimethylsilyl) phosphate, lithium oxalyldifluoroborate, lithium tetrafluorooxalate phosphate or lithium difluorophosphate.

7. The lithium ion battery electrolyte with improved wettability according to claim 6, wherein the film-forming additive is combination of vinylene carbonate, vinyl sulfate and tris(trimethylsilyl) phosphate.

8. The lithium ion battery electrolyte with improved wettability according to claim 1, wherein the solvent comprises at least two combinations of ethylene carbonate, propylene carbonate, dimethyl carbonate, diethyl carbonate, ethyl methyl carbonate, dipropyl carbonate, ethyl acetate, methyl acetate, ethyl propionate, propyl acetate or propyl propionate.

9. The lithium ion battery electrolyte with improved wettability according to claim 1, wherein the lithium salt comprises one or more of lithium hexafluorophosphate, lithium bis(fluorosulfonyl)imide or lithium bis(trifluoromethylsulfonyl)imide.

10. A lithium ion battery, comprising the lithium ion battery electrolyte according to claim 1, a positive electrode plate containing positive active materials, a negative electrode plate containing negative active materials and a diaphragm, wherein the positive active materials comprise one or more combinations of lithium cobaltate, lithium manganate, lithium nickelate, lithium iron phosphate, ternary nickel-cobalt-manganese materials, ternary nickel-cobalt-aluminum materials, or lithium-rich and manganese-based materials, and the negative active materials comprise one or more combinations of artificial graphite, natural graphite, soft carbon, hard carbon, silicon, silicon carbon, or silicon oxide.

11. The lithium ion battery according to claim 10, wherein a structural formula of the silanyl fluorobenzene compound is shown in Formula 1 or Formula 2, or the silanyl fluorobenzene compound is a combination of Formula 1 and Formula 2; 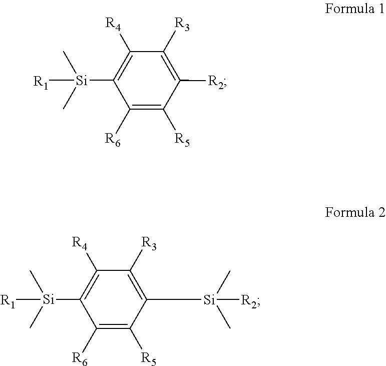
wherein R1, R2, R3, R4, R5 and R6 are all selected from hydrogen, halogen, substituted or unsubstituted alkanes, alkenes, alkynes, benzene rings or heterocyclic compounds.

12. The lithium ion battery according to claim 11, wherein the silanyl fluorobenzene compound is selected from at least one of T1 to T6 as follows:

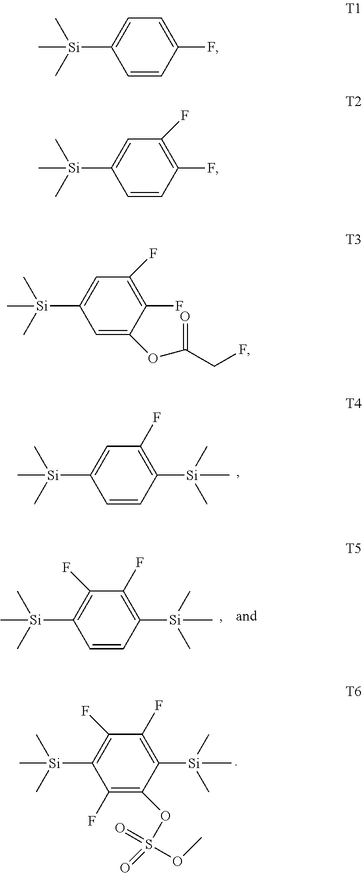

13. The lithium ion battery according to claim 12, wherein the wetting additive is combination of fluorobenzene, T3 and T6.

14. The lithium ion battery according to claim 10, wherein the film-forming additive comprises one or more of a carbon-containing additive, a sulfur-containing additive, a phosphorus-containing additive, a boron-containing additive, a nitrogen-containing additive and a silicon-containing additive.

15. The lithium ion battery according to claim 14, wherein the film-forming additive is one or more of vinylene carbonate, fluoroethylene carbonate, propane sultone, vinyl sulfate, methanesulfonyl dimethyl ester, tris(trimethylsilyl) phosphate, lithium oxalyldifluoroborate, lithium tetrafluorooxalate phosphate or lithium difluorophosphate.

16. The lithium ion battery according to claim 15, wherein the film-forming additive is combination of vinylene carbonate, vinyl sulfate and tris(trimethylsilyl) phosphate.

17. The lithium ion battery according to claim 10, wherein the solvent comprises at least two combinations of ethylene carbonate, propylene carbonate, dimethyl carbonate, diethyl carbonate, ethyl methyl carbonate, dipropyl carbonate, ethyl acetate, methyl acetate, ethyl propionate, propyl acetate or propyl propionate.

18. The lithium ion battery according to claim 10, wherein the lithium salt comprises one or more of lithium hexafluorophosphate, lithium bis(fluorosulfonyl)imide or lithium bis(trifluoromethylsulfonyl)imide.
